(19) United States
(12) Patent Application Publication
(10) Pub. No.: US 2010/0097827 A1
(43) Pub. Date: Apr. 22, 2010

(54) Method And Circuitry for Improving the Magnitude and Shape of the Output Current of Switching Power Converters

(75) Inventor: Shmuel Ben-Yaakov, Beer Sheva (IL)

Correspondence Address: MARSTELLER & ASSOCIATES, P O BOX 803302, DALLAS, TX, 75380-3302, US

(73) Assignee: Ben-Gurion University Of The Negev Research And Development Aurthority, Beer Sheva, IL (US)

(21) Appl. No.: 12/645,066

(22) Filed: Dec. 22, 2009

Related U.S. Application Data
(63) Continuation-in-part of application No. PCT/IL2008/000897, filed on Jun. 30, 2008.

(30) Foreign Application Priority Data
Jul. 2, 2007 (IL) 184358

(51) Int. Cl. H02M 7/5387; H02M 3/335

(52) U.S. Cl. 363/65; 363/132

(57) ABSTRACT

Apparatus of a grid-connected switching inverter for injecting it current into a power line comprises: (a) an electrical energy source for providing the substantially DC voltage to the apparatus; (b) a switching inverter connected to the electrical energy source for converting the substantially DC voltage of the electrical energy source to a high frequency alternating voltage; (c) a waveform generator for controlling the magnitude and shape of the alternating high frequency voltage outputted from the switching inverter by means of a control signal fed into the switching inverter; (d) an inductor connected to an output of the switching inverter for generating an alternating current from the alternating high frequency voltage, wherein the magnitude of the alternating current depends on a frequency of the alternating high frequency voltage: (e) a rectifier connected in series with the inductor for rectifying the alternating current and for outputting a rectified unipolar alternating current, wherein the rectified average value of the alternating current is proportional to the absolute magnitude of the power line voltage; and (t) a polarity commutator connected to an output of the rectifier for converting the rectified unipolar alternating current into a bipolar alternating current, and for injecting the bipolar alternating current into a power line, wherein the bipolar alternating current is substantially in phase with and of shape of the power line voltage of the power line.

### FIELD OF THE INVENTION

The present invention relates to switching power converters. More particularly, the invention relates to a method and circuitry for improving the magnitude and shape of the output current of switching power converters.

### BACKGROUND OF THE INVENTION

Currently, there are several types of power converters which are widely used for the DC-to-DC (Direct Current), DC-to-AC (Alternating current), AC-to-DC and AC-to-AC power conversion. In some applications, the purpose of the converter is to provide a regulated output voltage. In other applications, the purpose of the power conversion scheme is to regulate the output current independent of the load voltage. For example, in the case of a battery charger, the converter needs to feed the battery with a current rather than with a fixed output voltage. Another example is a grid-connected inverter for feeding energy into the power line. In this case, the required shape of the current is a sinusoidal waveform synchronized to the grid frequency having a magnitude that depends on the power capabilities of the source, which can be an array of photovoltaic cells, fuel cells, wind turbines and the like. Thus, a large family of applications requires that the switch mode converter behaves like a current source rather than a voltage source.

According to the prior art, two approaches have been suggested in the prior art to achieve the current source behavior. The first one is by adding a current feedback loop to a voltage source. The second approach is based on circuits that behave naturally as current sources. The advantage of the natural current source approach is that it does not rely on extra control loops that add to the cost of the units and reduce the reliability. The latter is due to the fact that current control loops of a voltage source converter are sensitive to deterioration of electrical components, spurious signals, noise and the like. Once the current loop is lost, the system may not only malfunction but could be severely damaged when the voltage sourcing converter is connected to a load which behaves like a voltage source. On the other hand, if the converter behaves naturally as a current source, there is no danger of runaway even without a dedicated current loop, since the converter keeps the current at a safe level by itself.

Currently, there is a growing use of converters that are required to behave like a current source in connection with the drive for alternative energy sources. Alternative energy sources such as solar cells and wind generators, can be used in an autonomous mode and grid-connected mode. In the first case, the generated energy is used to feed local loads. This mode of operation is rather limited in that it does not contribute to the general electrical energy needs. In the second case, in grid-connected mode, the energy is fed to power line when energy is available (during the day in case of solar cells or windy periods in the case of wind generators). Hence, the power grid serves, in a sense, as energy storage. When the alternative energy is available, it absorbs energy, and at that time, lowers the need for electrical energy generation by the grid power stations. When the alternative energy source is unavailable, the power line can still feed all loads connected to it.

The case of a grid-connected solar cells array is an example of a case in which electrical energy needs to be fed into a voltage source. The power line system behaves as a rigid voltage source with a low internal resistance. Hence, when connecting an external source to the grid, one has to make sure that energy flows from the source to the power line and not backward from grid to source. The latter not only constitutes a malfunction, but may cause severe damage to the feeding source. Another issue that needs to be carefully taken care of is the requirement of feeding the power line with a current of low harmonics content. That is, the shape of the injected current needs to be close to sinusoidal and in phase with the line voltage. This requirement is mandatory since the injection of high harmonic current is harmful; it increases power losses and could generate voltage interferences that might disturb other customers of the power line. Further, the recommended and mandatory standards, such as “EN61000-3-2”, set a limit to the high order harmonics that are allowed to be injected into the power line.

Most prior art solutions to the problem of current injection to the grid are based on generating a voltage source with a sinusoidal average output voltage and a filter inductor to reduce the ripple current. Typically, the sinusoidal voltage source is generated by a switch mode converter running at high switching frequency. The fundamental block diagram 100 of this prior art approach is depicted in FIG. 1. According to FIG. 1, an Electrical Energy Source 101 is feeding a switch mode DC-AC Converter 102 generating at its output 103 a switched voltage Vᵢₙᵥ with an average sinusoidal shape. Although the output is a sinusoidal signal, Converter 102 operates as a DC-DC converter with a time dependent output voltage. This voltage is fed into a filter inductor Lf to reduce the ripple current, and then to Power Line 107 via an optional Filter 105 to further reduce the high frequency ripple current. A Sensor 106 measures the current Iₒᵤₜ that is injected into Power Line 107, and generates a signal on line 110 that is proportional to the injected current Iₒᵤₜ. This signal is compared to a line voltage reference signal 109 by a Control Unit 108 that adjusts the output of DC-AC Converter 102, such that the injected current will follow a sinusoidal shape synchronized to the line voltage. The need for the feedback arrangement via Control Unit 108 is clear to a person in the art, considering the voltage sourcing nature of this injection circuitry 200, shown generically in FIG. 2. According to FIG. 2, the prior art method is described in its fundamental nature as an AC Voltage Source 101 feeding Power Line 107 via a Filter Inductor 104, which is inserted for the purpose of reducing the high frequency ripple current. However, since the impedance of this inductor to the line frequency (50 Hz or 60 Hz depending on country) is very small, any voltage deviations between a Voltage Source 101 and a Power Line 106 will cause large uncontrolled current. To harness this undesired behavior, a current feedback loop must be included in the system. Even so, the reliability of such a system is low, since a loss of the current feedback, due to noise or failure of components will be catastrophic. Furthermore, the inclusion of a feedback loop may cause dynamic instability and will add to the cost of the system.

FIG. 3 is an example of the voltage source implementation 300, according to the prior art, as described in US 2005/0180175. Similarly to FIG. 1, the circuitry of FIG. 3 comprises Voltage/Electrical Source 101, DC-DC converter 102, Filter Inductor L_{f}, Power Line 107, and Control Unit 108.

Another prior art approach for current injection is described in connection with electronic ballasts for HID (High Intensity Discharge) lamps. Discharge lamps need to be fed by a current source to maintain stable operation. For example, such an approach is described in U.S. Pat. No. 7,084,584, as illustrated in FIG. 4. In this case, a current source Id rather than a Voltage Source 102 (FIG. 2) is fed to the load (Lamp), after some polarity processing. Notwithstanding the fact that current injection approach of U.S. Pat. No. 7,084,584 is superior to that of the voltage source scheme, the teaching of U.S. Pat. No. 7,084,584 does not include the generation of a sinusoidal current as is required in the case of a grid (Power Line) injection. Also, the teaching of U.S. Pat. No. 7,084,584 does not cover the issue of maximum power point tracking (MPPT) as is required in the case of alternative energy sources. The MPPT is required for extracting the maximum possible energy from the source. For example, as known to workers in the field, maximum energy is obtained from a solar cell panel when loaded by a load that exhibits a specific resistance value. Hence, for the optimal operation in terms of highest efficiency, the system that connects an alternative energy source to the grid must not only behave as a current source, but needs to track the maximum power point.

According to the prior art, a number of approaches have been proposed to realize the inherent current source behavior. One approach is based on a buck-boost or flyback converter. In this case the magnetic element is charged by the primary energy source and discharges into the load or power line (in the case of a grid-connected system). Such approach is disclosed in U.S. Pat. No. 7,084,584, as illustrated on FIG. 5. By turning the switch Q₁₄ ON an OFF, the coupled inductor L₁ is charged via its primary wing and discharged by the secondary wing; Q₉ and Q₁₀ are then used as polarity reversal switches to generate a bipolar square wave current at the load (HID Lamp). This concept was presented by Kyritsis et al. (A. C. Kyritsis, N. P. Papanikolaou, E. C. Tatakis, and J. C. Kobougias, “Design and control of a current source flyback inverter for decentralized grid connected photovoltaic systems,” European Conference on Power Electronics and Applications, 2005, pp. 1-10, 11-14, September 2005) to realize a grid-connected system illustrated in FIG. 6. Although the arrangement of the polarity reversal switches (S₂, S₃) is somewhat different from the illustrated in FIG. 5, the two circuits presented on these figures are identical in concept and implementation, except for the arrangement of switches and diodes. The shortcomings of the circuit presented on FIG. 5, as a source for a grid-connected system, are: poor utilization of the magnetic element; high voltage stresses on the primary switch; voltage spikes associated with the parasitic inductance of the coupled inductor; the pulsating current at the output; and low energy levels that can be processed by a flyback stage at reasonable losses. Another way to realize a current sourcing circuit is by using the AC inductor, as is demonstrated in U.S. Pat. No. 7,084,584 and shown in FIG. 7. In this case, an inductor L₈ is subject to a high frequency AC voltage and consequently exhibits a high impedance. This high impedance serves as a current limiter realizing thereby the current sourcing nature of the system. One of the additional major advantages of this system is that the transistors operate under zero voltage switching due to the phase lag of the inductor's current and the reversal of current every half cycle. However, the system of FIG. 7 does not generate a sinusoidal current, synchronized to the power line voltage, as is required for the grid (power line) connected source.

Therefore, there is a continuous need for providing current sourcing soft-switched inverters based on “AC inductors” that can be used reliably to inject to the grid a sinusoidal current, synchronized to the power line voltage. It is further desirable that such converters will be capable of operating without a current loop, or if a current loop is used, not to go astray or be damaged, when the current feedback is lost.

It is an object of the present invention to provide a method and circuitry for injecting a current into an output voltage source, such as a power line, while presenting to the input electrical energy source, such as a solar cell panel, the desired characteristics, such as the optimum loading for achieving the maximum power.

It is another object of the present invention to provide a method and circuitry for connecting an alternative energy source to the power line by a current source circuitry to reduce the cost and increase the reliability of the system.

It is still another object of the present invention to provide economical and efficient method and circuitry for improving the performance and reliability of switch mode based systems that behave as sinusoidal current sources.

It is still another object of the present invention to provide a method and circuitry for tracking the maximum power point of a source and behaving as a current source with respect to its load.

It is still another object of the present invention to provide a method and circuitry for transferring energy from an electrical energy source to power line by using an AC inductor as a current limiter and adjuster.

It is a further object of the present invention to provide a method and circuitry of a switch-mode inverter suitable for grid connection applications, which has improved reliability and improved programmability features compared to prior art grid-connected inverters.

It is still a further object of the present invention to provide a method and circuitry, in which a current feedback loop is not required for the basic operation of injection of a current into a power line.

It is still a further object of the present invention to provide a method and circuitry, in which the injection of a current into a power line is not influenced by distortions of the current within said power line.

It is still a further object of the present invention to provide a method and circuitry, in which the soft switching is provided for maintaining the output current signal substantially undistorted.

It is still a further object of the present invention to provide a method and circuitry, which is relatively inexpensive.

Other objects and advantages of the invention will become apparent as the description proceeds.

### SUMMARY OF THE INVENTION

Hereinafter, when the term “inherent current source” is mentioned, it should be understood that it refers to a source that can inject the desired current independently from the voltage of the load.

The present invention is directed to a method and circuitry (apparatus) that behaves as an inherent current source, for injecting a sinusoidal current into a power line. According to an embodiment of the present invention, a current feedback loop is not required for the basic injection operation. In addition, if a current feedback loop is not used, undesired currents will not be injected to the grid, and the circuitry will not be damaged by the grid when the current feedback loop is lost.

The apparatus of a grid-connected switching inverter for injecting a current into a power line comprises: (a) an electrical energy source for providing the substantially DC voltage to said apparatus; (b) a switching inverter connected to said electrical energy source for converting said substantially DC voltage of said electrical energy source to a high frequency alternating voltage; (c) a waveform generator for controlling the magnitude shape and frequency of said alternating high frequency voltage outputted from said switching inverter by means of a control signal fed into said switching inverter; (d) an inductor connected to an output of said switching inverter for generating an alternating current of variable magnitude and frequency from said alternating high frequency voltage, wherein the magnitude of said alternating current depends on a frequency of said alternating high frequency voltage; (e) a rectifier connected in series with said inductor for rectifying said alternating current and for outputting a rectified unipolar alternating current, wherein the rectified average value of said alternating current is proportional to the absolute magnitude of the power line voltage; and (f) a polarity commutator connected to an output of said rectifier for converting said rectified unipolar alternating current into a bipolar alternating current, and for injecting said bipolar alternating current into a power line, wherein said bipolar alternating current is substantially in phase with and of shape of said power line voltage of said power line.

According to an embodiment of the present invention, the apparatus further comprises a MPPT unit for tracking the maximum power point of the electrical energy source.

According to another embodiment of the present invention, the electrical energy source is one or more of the following: (a) a solar cell; (b) a fuel cell; (c) a wind turbine; (d) a battery or accumulator; and (e) a generator.

According to a particular embodiment of the present invention, the switching inverter is a H-bridge or half bridge switching inverter.

According to another particular embodiment of the present invention, the polarity commutator is a H-bridge or half bridge polarity commutator.

According to still another particular embodiment of the present invention, the switching inverter comprises two or more switches that are driven by means of high frequency control signals outputted from high frequency drivers.

According to a further particular embodiment of the present invention, the polarity commutator comprises two or more switches that are driven by means of low frequency signals outputted from low frequency drivers.

According to an embodiment of the present invention, the magnitude of the alternating current of the inductor depends on the duty cycle of the control signal fed to the inverter.

According to another embodiment of the present invention, the magnitude of the alternating current of the inductor is controlled by means of sequences of ON and OFF periods of the high frequency control signal fed to the inverter.

According to still another embodiment of the present invention, the magnitude of the alternating current of the inductor is controlled by means of the duty cycle of the control signal fed to the inverter.

According to still another embodiment of the present invention, the apparatus further comprises a pulse width modulation unit for keeping a signal switching the switches at a predefined maximal frequency.

According to still another embodiment of the present invention, the apparatus further comprises a line synchronizer for sensing the line voltage and generating corresponding synchronization commands.

According to still another embodiment of the present invention, the synchronization commands are fed into the low frequency drivers.

According to still another embodiment of the present invention, the synchronization commands are fed into the waveform generator.

According to a particular embodiment of the present invention, the apparatus further comprises an overvoltage protection unit for guarding said apparatus from dangerous DC voltage levels under no load conditions.

According to a further embodiment of the present invention, the apparatus further comprises a microcontroller for controlling the operation of said apparatus.

According to still a further embodiment of the present invention, the apparatus further comprises a transformer for galvanically isolating the electrical energy source from the power line.

According to still a further embodiment of the present invention, the apparatus further implements soft switching of the switches of the inverter for reducing the power and stresses of said switches.

According to still a further embodiment of the present invention, the apparatus further comprises a DC-DC converter, placed between the electrical energy source, and switching inverter for adjusting the voltage level of said electrical energy source to that required for said switching inverter.

According to still a further embodiment of the present invention, the alternating current is generated in the inductor due to imposing a bipolar high frequency voltage across said inductor.

According to still a further embodiment of the present invention, the alternating current in the inductor is controlled by varying the frequency of the bipolar high frequency voltage.

According to still a further embodiment of the present invention, the alternating current in the inductor is controlled by toggling the bipolar voltage signal ON and OFF.

According to still a further embodiment of the present invention, the alternating current in the inductor is controlled by varying the ON time within each switching period of the bipolar voltage.

The method for injecting a current into a power line comprises: (a) providing an inductor, a terminal of which is, connected in series to a first input of a rectifier; (b) generating an alternating current of variable magnitude and frequency in said inductor by applying a high frequency voltage between the other terminal of said inductor and a second input of said rectifier; (c) rectifying said alternating current by means of said rectifier, thereby obtaining the magnitude of the rectified average value of the alternating current that is proportional to the absolute magnitude of the power line voltage; (d) commutating the polarity of the rectified alternating current to be synchronized with the phase of the power line current; and (e) injecting the synchronized rectified alternating current into said power line.

The method for injecting a current into a power line comprises: (a) providing the substantially DC voltage by means of an electrical energy source; (b) converting said substantially DC voltage of said electrical energy source to a high frequency alternating voltage by means of a switching inverter connected to said electrical energy source; (c) controlling the magnitude shape and frequency of said alternating high frequency voltage outputted from said switching inverter by means of a control signal fed into said switching inverter from a waveform generator; (d) generating an alternating current of variable magnitude and frequency from said alternating high frequency voltage by means of an inductor connected to an output of said switching inverter, wherein the magnitude of said alternating current depends on a frequency of said alternating high frequency voltage; (e) rectifying said alternating current and outputting a rectified unipolar alternating current by means of a rectifier connected in series with said inductor, wherein the rectified average value of said alternating current is proportional to the absolute magnitude of the power line voltage; and (f) converting said rectified unipolar alternating current into a bipolar alternating current and injecting said bipolar alternating current into a power line by means of a polarity commutator connected to an output of said rectifier, wherein said bipolar alternating current is substantially in phase with and of shape of said power line voltage of said power line.

### BRIEF DESCRIPTION OF THE DRAWINGS

In the drawings:

FIG. 1 is a schematic illustration of a voltage source grid-connected inverter, according to the prior art;

FIG. 2 is a schematic illustration of the connection of a voltage source inverter to a power line, according to the prior art;

FIG. 3 is a schematic illustration of the power stage of a voltage source inverter connection to the power line, according to the prior art;

FIG. 4 is a schematic illustration of the connection of a current source HID (High Intensity Discharge) lamp ballast, according to the prior art;

FIG. 5 is a schematic illustration of the connection of a current source HID lamp ballast implemented by a flyback converter, according to the prior art;

FIG. 6 is a schematic illustration of a flyback-based grid-connected inverter, according to the prior art;

FIG. 7 is a schematic illustration of a current source HID lamp ballast implemented by a half-bridge inverter and an AC inductor, according to the prior art;

FIG. 8 is a schematic block diagram of a circuitry of a grid-connected inverter, according to an embodiment of the present invention;

FIG. 9 is a schematic illustration of waveforms of signals of FIG. 8, according to an embodiment of the present invention;

FIG. 10 is a schematic block diagram of a circuitry of a grid-connected inverter, according to another embodiment of the present invention;

FIG. 11 is a schematic illustration of a buck converter stage of a circuitry of a grid-connected inverter, according to an embodiment of the present invention;

FIG. 12 is a schematic illustration of a circuitry of grid-connected inverter, according to still another embodiment of the present invention;

FIG. 13 is a schematic illustration of waveforms of signals of FIG. 12, according to an embodiment of the present invention;

FIG. 14 is a schematic illustration of the output current waveform of FIG. 12, according to an embodiment of the present invention;

FIG. 15 is a schematic illustration of a circuitry of a microcontroller-based grid-connected inverter, according to an embodiment of the present invention;

FIG. 16 is a schematic illustration of a circuitry of a half-bridge based grid-connected inverter, according to an embodiment of the present invention;

FIGS. 17 and 18 are schematic illustrations of waveforms of a current I_{Lh} of inductor Lₕ and of an output current Iₒᵤₜ, according to another embodiment of the present invention; and

FIGS. 19 and 20 are schematic illustrations of waveforms of a current I_{Lh} of inductor Lₕ and of a current I_{R}, according to still another embodiment of the present invention.

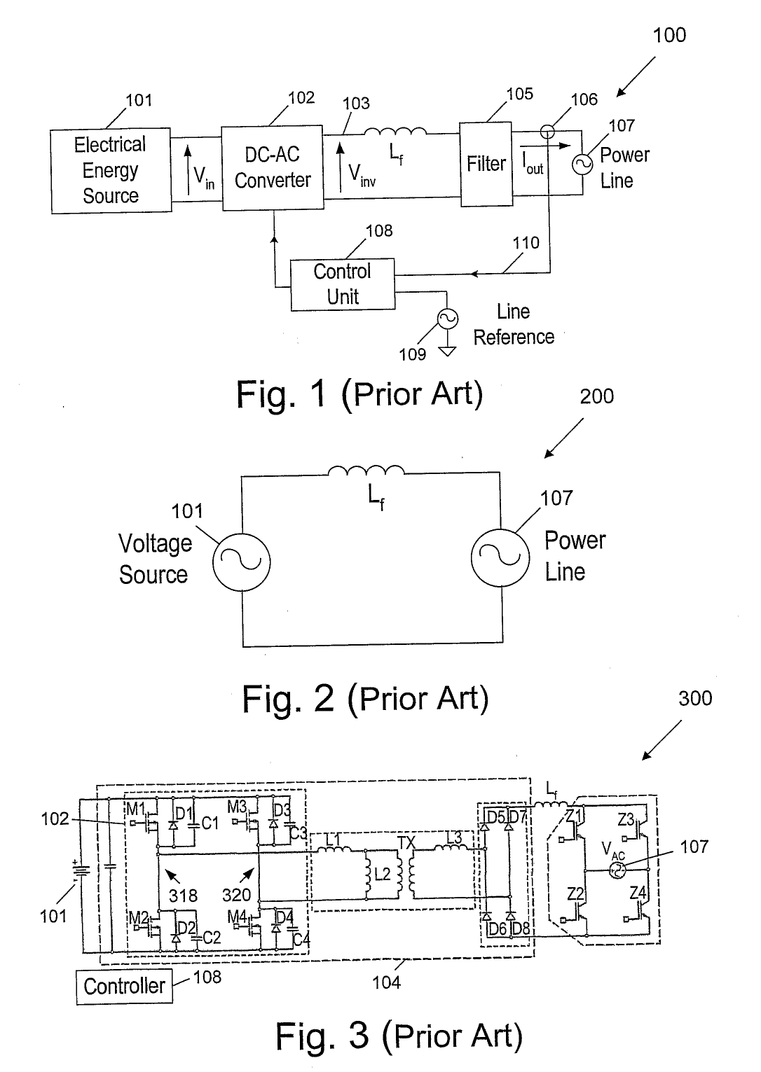

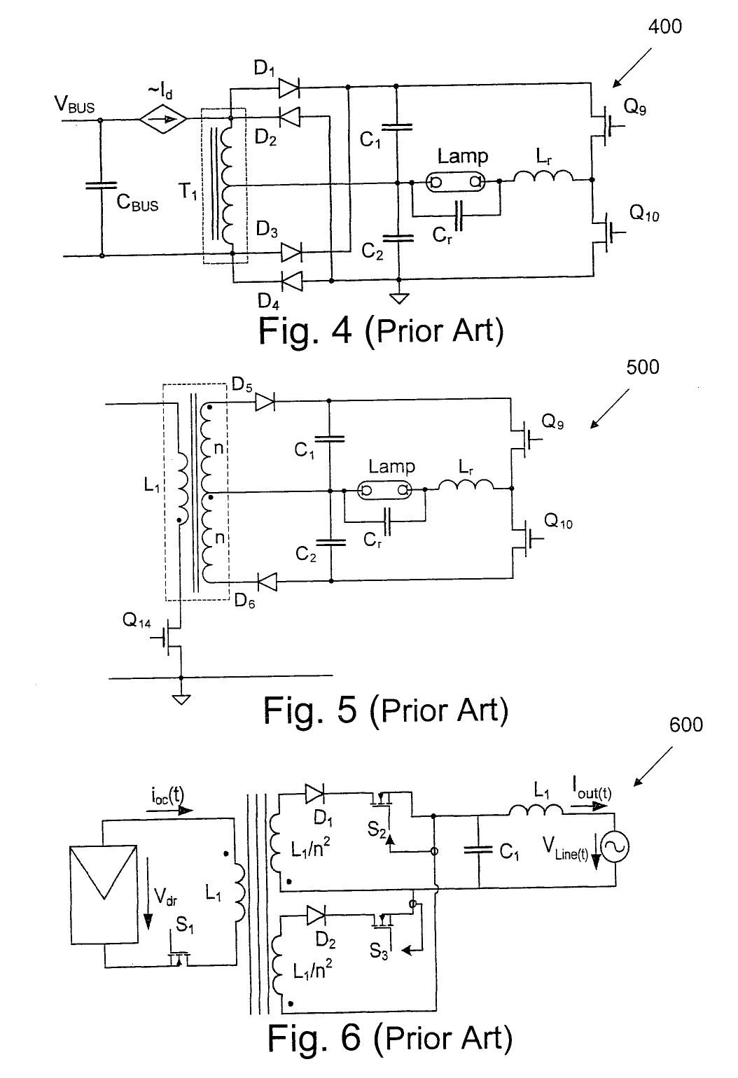

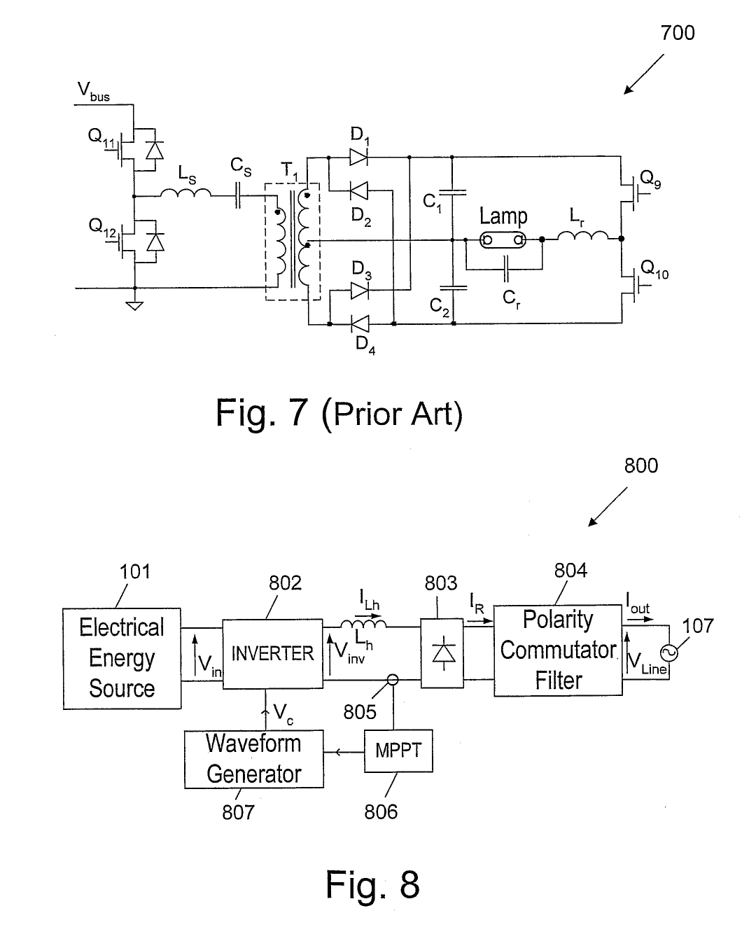

### DETAILED DESCRIPTION OF THE PREFERRED EMBODIMENTS

The present invention is directed to a method and circuitry (apparatus) that behaves as an inherent current source, for injecting a sinusoidal current into a power line.

FIG. 8 is a schematic block diagram 800 of a of a circuitry (apparatus) of a grid-connected inverter for injecting a current into a Power Line 107, according to an embodiment of the present invention. The circuitry of the grid (Power Line 107) connected inverter comprises: an Electrical Energy Source 101 for providing the substantially DC voltage to said circuitry; an Inverter 802 for converting said substantially DC voltage of said Electrical Energy Source 801 to a high frequency alternating voltage Vᵢₙᵥ; a Waveform Generator 807 for controlling said high frequency alternating voltage Vᵢₙᵥ by means of a control signal V_{c} fed into said Inverter 802; an inductor Lₕ connected in series to an output of said Inverter 802 for generating an alternating current I_{Lh} due to the high frequency alternating voltage Vᵢₙᵥ; a Rectifier 803 connected to said inductor Lₕ for rectifying said high frequency alternating current I_{Lh}; a Polarity Commutator 804 connected to said Rectifier 803 for converting said rectified unipolar alternating current into a bipolar alternating current Iₒᵤₜ and for injecting said bipolar alternating current Iₒᵤₜ into a power line (grid); and, optionally, a MPPT unit for tracking the maximum power point of said circuitry 800 to operate it with maximal (optimal) efficiency.

It should be noted that the alternating voltage Vᵢₙᵥ imposed on inductor Lₕ, causes it to operate as an AC inductor. Such voltage generates an alternating current I_{Lh} with a temporal magnitude that depends on the switching frequency and the wave form of Vᵢₙᵥ. These are controlled by signal V_{c} that is generated by the Waveform Generator 807. By changing this control voltage as a function of time, the current I_{Lh} can be increased or decreased. For example, if the frequency of V_{c} is decreased, the switching frequency of the inverter will decrease and the Vᵢₙᵥ frequency will be lower. This will increase the current I_{Lh} due to the fact that the impedance of an inductor becomes lower at lower frequencies. V_{c} can thus change the output voltage Vᵢₙᵥ such that the envelope of I_{Lh} will be sinusoidal. After passing a Rectifier 803, the average current is unipolar having the form of a rectified sinusoidal wave. It should be noted that the rectified average value of the alternating current is proportional to the absolute magnitude of the power line voltage. The unipolar current is then converted into a bipolar AC current Iₒᵤₜ by a Polarity Commutator 804 that might include a filter to attenuate the high frequency ripple current.

According to an embodiment of the present invention, MPPT unit 806 measures by means of a sensor 805 the magnitude of I_{Lh}, which in turn reflects the current injected to the grid (Power Line 107), and adjusting signal V_{c} (the Duty cycle of signal V_{c}) outputted from Waveform Generator 807 such that I_{Lh} has the maximum possible value. For a given Vₗᵢₙₑ, a maximum Iₒᵤₜ (when I_{Lh} also has the maximal value) is, by definition, the maximum power point.

It should be noted that Electrical Energy Source 101 can be any electrical source, such as one or more solar, fuel cells, wind turbines, batteries, accumulators, (diesel) generators, etc.

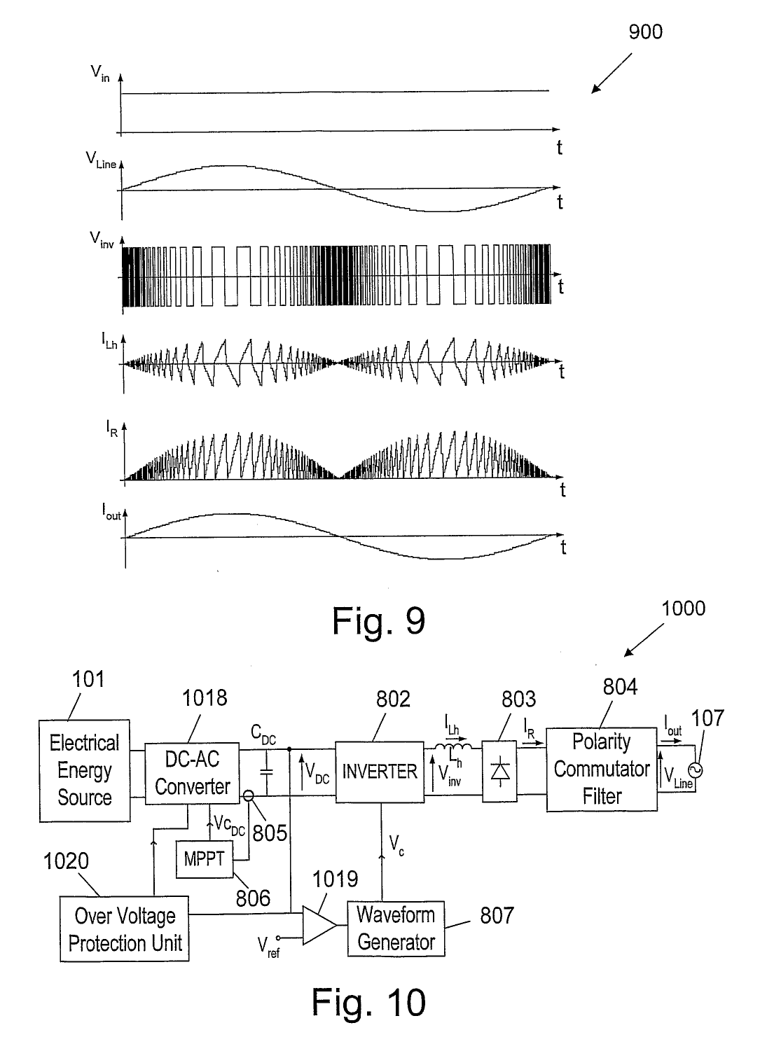

FIG. 9 is a schematic illustration 900 of waveforms of signals of FIG. 8, according to an embodiment of the present invention. V_{Line} is an output voltage and a voltage of Power Line 107 (it is shown as a time reference); Vin represents an input DC voltage Vin of Electrical Energy Source 101; the voltage Vᵢₙᵥ at an output of Inverter 802 is shown as a sequence of pulses with variable frequency and possibly variable pulse width; I_{Lh} is a current through AC inductor Lₕ, reflecting the variable voltage Vᵢₙᵥ on said AC inductor Lₕ; I_{R} is a current at the output of Rectifier 803, showing its unipolar nature; and Iₒᵤₜ is an output current of circuitry 800, injected to Power Line (grid) 107 after performing polarity commutation and filtering by means of Polarity Commutator Filter 804.

FIG. 10 is a schematic block diagram 1000 of a circuitry of a grid-connected inverter, according to another embodiment of the present invention. According to this embodiment, a front end DC-DC converter 1018 is placed between Electrical Energy Source 101 and Inverter 802. The purpose of said DC-DC converter 1018 is to adjust the voltage level of Electrical Energy Source 101 to that required for Inverter 802. For example, if low voltage solar cell array is used (e.g., for safety reason, economics, redundancy and the like), and the optimum input voltage to the inverter is higher than said low voltage (from an operational point of view, efficiency and the like), the DC-DC converter 1018 adjusts the voltage levels. According to an embodiment of the present invention, for ensuring the maximum power point tracking of circuitry 1000, MPPT unit 806 can be placed around DC-DC converter 1018, as illustrated on FIG. 10. MPPT unit 806 will extract the maximum power from Electrical Energy Source 101, feeding it to an output capacitor C_{DC} for storage. To guard from dangerous V_{DC} levels under no load conditions, circuitry 1000 can also comprise an Overvoltage Protection Unit 1020. In the normal operation, Inverter 1012 increases the AC inductor current I_{Lh} (that is proportional to the line injected current Iₒ) until V_{DC} is stabilized around the desired value. This is accomplished in present invention by measuring V_{DC} and comparing the measured value to the desired voltage V_{ref}. This comparison is carried out by an Error Amplifier/Compensator 1019 that feeds Waveform Generator 807.

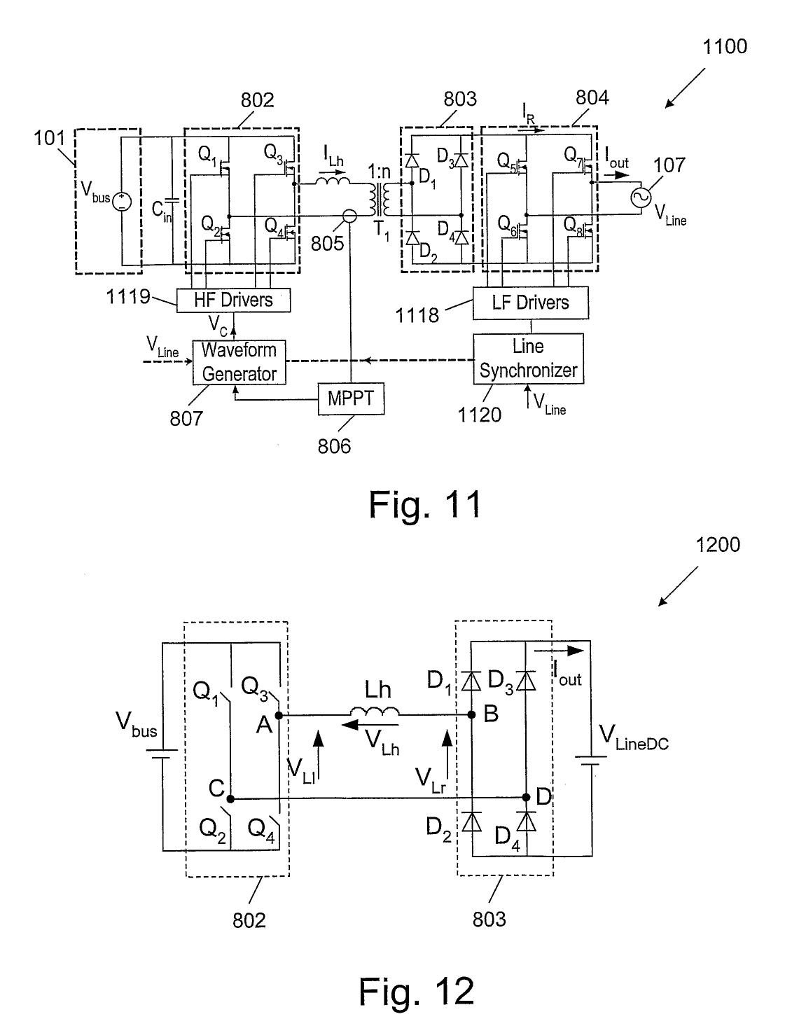

FIG. 11 is a schematic illustration 1100 of a buck converter stage of a circuitry of a grid-connected inverter, according to an embodiment of the present invention. According to this embodiment, Inverter 802 is implemented by a high frequency H-bridge configuration having switches Q₁-Q₄, which are driven by HF (High Frequency) Drivers 1119. Polarity Commutator 804 (FIG. 10) is implemented by a low frequency H-bridge realized by switches Q₅-Q₈ driven by a LF (Low Frequency) Drivers 1118. The line synchronization command is generated by a Line Synchronizer 1120 that sense the line voltage and generates the synchronization commands that is fed to LF Drivers 1118 and, optionally, to Waveform Generator 807. Due to said synchronization commands, the rectified alternating current I_{R} is synchronized with the phase of the power line current Iₒᵤₜ. Waveform Generator 807 can receive the V_{Line} signal, which is proportional to the signal of Power Line 107. The operation of Waveform Generator 807 can be based on the waveform of V_{Line} or on a sinusoidal oscillator locked to the power line frequency by a phase lock loop (PLL) or similar circuits.

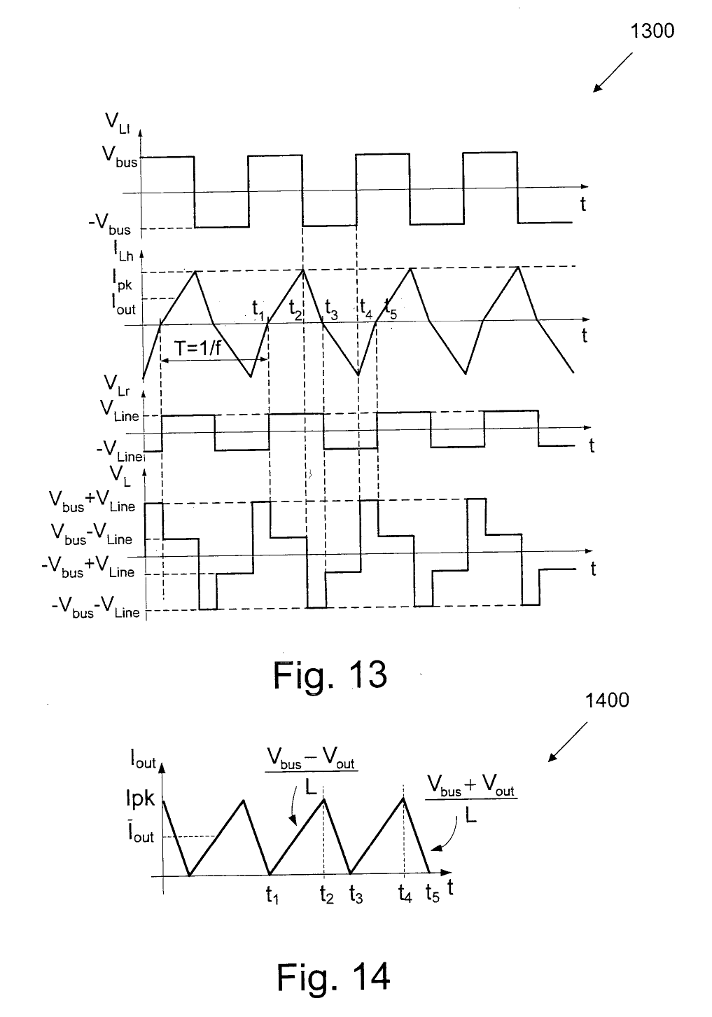

The generation of the required current to be injected to AC Power Line 107 requires the generation of control signals V_{c} by the waveform generator, such that the average waveform of the current I_{R} (I_{Lh} after rectification) and, in turn, the average waveform of the output current Io, will be sinusoidal. According to an embodiment of the present invention, this requirement is met by controlling the inverter according to the mathematical relationship between the output of the inverter 802, the inductor current I_{Lh} and the outputted current to the grid. This relationship is shown in reference to FIGS. 12 and 13 below.

In FIG. 12, an output Inverter (Polarity Commutator) 804, which is implemented by means of switches Q₅ to Q₈, is switched at the line frequency (e.g., 50 Hz) so that the voltage reflected to the output of Rectifier 803 (implemented by means of diodes D₁ to D₄) is always positive. For simplicity of the mathematical derivation given below (in reference to FIG. 13), it is assumed that the line voltage V_{Line} is constant over a switching cycle this assumption is correct because the switching frequency is much higher than the line frequency. For example, if the HF Drivers 1119 (FIG. 12) switching frequency is 50 kHz, then the period of each switching cycle is 20 microseconds. During such a short time, the line voltage does not change appreciably, since the power line frequency is 50 Hz or 60 Hz. That is, the duration of one switching cycle is about one thousandth of the line period. During this relative short duration that represents much less than one degree of the line phase angle, the line voltage does not change much and hence can be considered constant for that and neighboring periods of the switching frequency. Therefore, for a given voltage point of the line voltage, the power stage of FIG. 11 can be simplified to the circuit of FIG. 11. It includes the energy source V_{bus}, inverter 802, inductor Lₕ, diodes 803 and the reflected line voltage V_{LineDC} [change in FIG. 12 V_{Line} to V_{LineDC}] assumed to be constant for the analysis instance. Polarity Commutator 804 is not shown in FIG. 12, because it is locked during the period of interest to one position. That is, either both Q₅ and Q₈ are conducting or both Q₇ and Q₆ are conducting—it depends on the momentary polarity of the line voltage.

It is assumed that circuit 1200 of FIG. 12 operates with 50% Duty Cycle, and hence, a symmetrical bipolar square wave signal V_{L1} is generated at the output of inverter 802. In this case, the voltages applied to both terminals (points A and B) of AC inductor Lₕ are bipolar and the inductor's current I_{Lh} flows in both directions with zero average component since the voltages of 802 and 803 do not include a DC components. This is because the switches are run at 50% Duty cycle, and hence generate bipolar waveforms. However, due to non-symmetry of the inverter's output voltage, a DC error component may appear at terminal A of inductor Lₕ. This DC error component can be removed by a series capacitor, or by applying peak current control. Due to the output diode bridge (diodes D₁ to D₄), the polarity of the voltage V_{Lr} that is seen at terminal B of inductor Lₕ is reversed every zero-crossing of the inductor's current.

During time interval t₁-t₂ (FIG. 13) voltage V_{L1} at the input side (at terminal A) of inductor Lₕ is positive (V_{bus}), the inductor's current is positive and diodes D₁ and D₃ are at their conducting state. Consequently, the voltage seen by the inductor is positive and equal to V_{bus}−Vₗᵢₙₑ; and the inductor's current is positive and is increasing. At t₂, the polarity of the input voltage switches. The current through the inductor keeps flowing in the same direction, so diodes D₁, D₃ keep conducting. The voltage applied to the inductor will now be negative and equal to (−V_{bus}−Vₗᵢₙₑ) and the inductor's current will start decreasing. At t₃, the inductor's current crosses zero and its polarity reverses. As a result, diodes D₂ and D₄ are turned on; voltage V_{Lr} seen by terminal B of inductor Lₕ is Vₒᵤₜ; and the net voltage applied to the inductor is −V_{bus}+Vₗᵢₙₑ. That is, the magnitude of the voltage applied to the inductor during time interval t₃-t₄ is equal to that of time interval t₁-t₂, but opposite in polarity. Similarly, the inductor's voltage during time interval t₄-t₅ is equal in magnitude but opposite in polarity to that of time interval t₂-t₃. Consequently, the current through the inductor reverses its polarity every input voltage switching cycle.

FIG. 13 is a schematic illustration 1300 of waveforms of signals of FIG. 12, according to an embodiment of the present invention. The illustrated signals are:
voltage V_{L1} between terminal A of inductor Lₕ and terminal C of switch Q₄;
current I_{Lh} passing through inductor Lₕ;
voltage V_{Lr} between terminal B of inductor Lₕ and terminal D of switch Diode D₃; and
voltage V_{Lh} across inductor Lₕ.

During the time interval t₁-t₂, the peak inductor current Iₚₖ is:

$${I}_{p k} = \frac{{V}_{bus} - {V}_{Line}}{L} ( {t}_{2} - {t}_{1} ) \qquad ( 1 )$$

where L is the inductance of inductor Lₕ. Similarly, during the time interval t₂-t₃, Iₚₖ is expressed as:

$${I}_{p k} = \frac{{V}_{bus} + {V}_{Line}}{L} ( {t}_{3} - {t}_{2} ) \qquad ( 2 )$$

From (1) and (2), taking into account that (t₃-t₁) is half a switching cycle, yields:

$$( {t}_{2} - {t}_{1} ) + ( {t}_{3} - {t}_{2} ) = {I}_{p k} L \frac{2 {V}_{bus}}{{V}_{bus}^{2} - {V}_{Line}^{2}} = \frac{1}{2 F} \qquad ( 3 )$$

where F is the switching frequency. Rearranging (3) back for Iₚₖ, leads to:

$${I}_{p k} = \frac{{V}_{bus}^{2} - {V}_{Line}^{2}}{4 {LFV}_{bus}} \qquad ( 4 )$$

FIG. 14 is a schematic illustration 1400 of the output current waveform of FIG. 12, according to an embodiment of the present invention. The output current Iₒᵤₜ is the rectified inductor's current. Since output current Iₒᵤₜ is of a triangular shape, its average value is a half of its peak value:

$${\overline{I}}_{out} = \frac{1}{2} {I}_{p k} = \frac{{V}_{bus}^{2} - {V}_{Line}^{2}}{8 {LFV}_{bus}} \qquad ( 5 )$$

where Īₒᵤₜ is the output current averaged over the switching cycle.

It should be noted that the equation (5) is obtained considering some time instant t. Thus, output current Īₒᵤₜ of inverter 802 (FIG. 12) over the line cycle is defined as following:

$${\overline{I}}_{out} ( t ) = \frac{{V}_{bus}^{2} - {V}_{Line}^{2} ( t )}{8 LF ( t ) {V}_{bus} } \qquad ( 6 )$$

According to an embodiment of the present invention, grid-connected inverter 802 delivers the current which is in phase with and of shape of the line voltage V_{Line}. The line voltage is considered as:

V_{Line}(t)=Vₒᵤₜ(t)=Vᵣₘₛ\sqrt{2} sin 2πfₗᵢₙₑt (7)

where Vᵣₘₛ is the RMS (Root Mean Square) line voltage, and fₗᵢₙₑ is the line frequency.

Consequently, the inverters output current is given by:

$${\overline{I}}_{out} ( t ) = \frac{{P}_{out}}{{V}_{r m s}} \sqrt{2} sin 2 π {f}_{line} t = \frac{{P}_{out} {V}_{out} ( t )}{{V}_{r m s}^{2}} \qquad ( 8 )$$

where Pₒᵤₜ is an average power delivered to the line. Substituting (8) into (6) yields:

$$F ( t ) = \frac{{V}_{rm s}^{2}}{8 {LP}_{out}} \frac{{V}_{bus}^{2} - {V}_{Line}^{2} ( t )}{{V}_{bus} {V}_{Line} ( t )} \qquad ( 7 )$$

As a result, if the switching frequency F(t) is set (programmed) according to (7), output current Īₒᵤₜ will follow the line voltage. In addition, it follows from (7) that when the line voltage is low, the frequency can go too high. Therefore, according to another embodiment of the present invention, this problem is overcome by providing a PWM (Pulse Width Modulation) unit. That is, the control signal is kept at some predefined maximum frequency Fₗᵢₘ awhile; the pulse width (tₒₙ) of the control signal is varies to generate the desired current level. It can be shown that the average output current will follow the line voltage, if tₒₙ is programmed according to (8):

$${t}_{on} ( t ) = \sqrt{\frac{{P}_{out} {V}_{Line} ( t ) L}{{V}_{rms}^{2} {V}_{bus}} \frac{{V}_{bus} + {V}_{Line} ( t )}{{V}_{bus} - {V}_{Line} ( t )} \cdot \frac{1}{{F}_{l i m}}} \qquad ( 8 )$$

The signal V_{Line}(t) can be obtained by sampling the output voltage, from a local oscillator locked to the power line frequency or from a table stored in a digital memory. As a result, the magnitude and shape of the output current of circuitry 1100 is improved.

According to still another embodiment of the present invention, the drive frequency F(t) and tₒₙ(t) are generated by a circuit that compares current I_{Lh} of inductor Lₕ and the waveform of V_{Line}. The deviations are translated into the excitation of voltage V_{c} (FIG. 11).

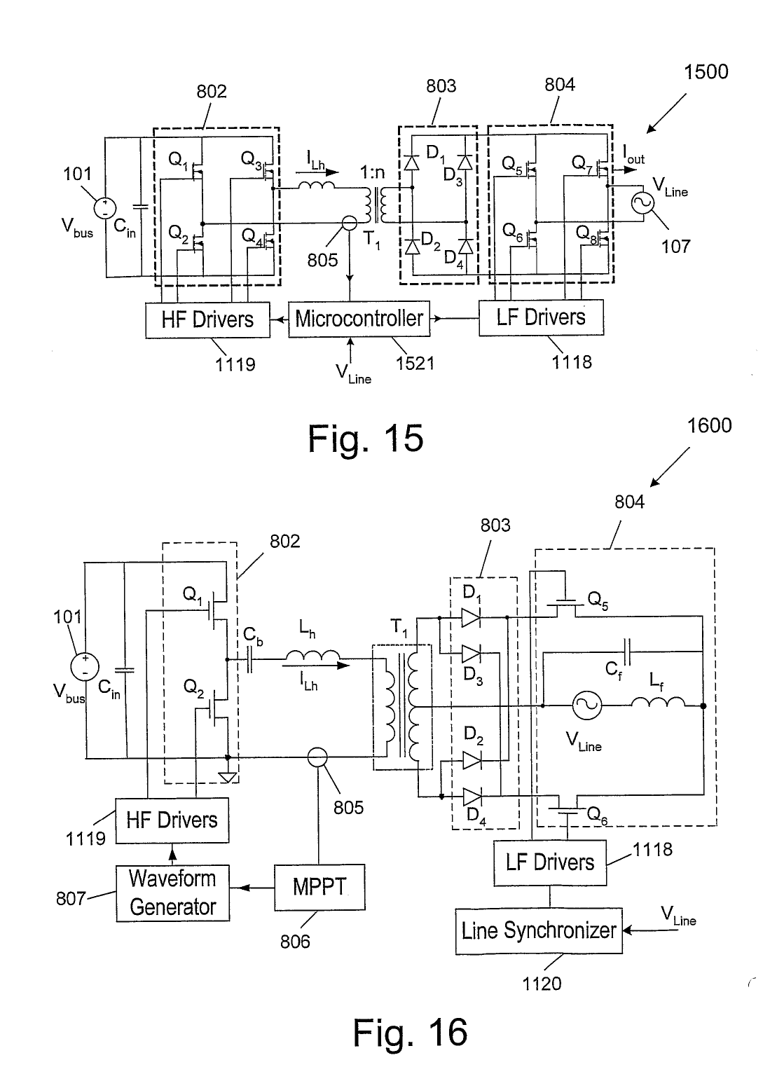

FIG. 15 is a schematic illustration 1500 of a circuitry of a microcontroller-based grid-connected inverter, according to an embodiment of the present invention. According to this embodiment, the electrical energy source is galvanically isolated from the line by a transformer T₁. A digital microcontroller 1521 carries out a specific algorithm for operating the circuitry, said operating includes line synchronization, MPPT, waveform generation, switch driving and etc. Said digital microcontroller 1521 can be used to control the two stage system: Inverter 802 and Polarity Commutator 804 by means of HF (High Frequency) 1119 and LF (Low Frequency) Drivers 1118, respectively.

FIG. 16 is a schematic illustration 1600 of a circuitry of a half-bridge based grid-connected inverter, according to an embodiment of the present invention. According to this embodiment, Inverter 802 and Polarity Commutator 804 are realized by half bridge topologies. In this case, inverter 802 is represented by a high frequency half bridge configuration containing switches Q1 and Q2, and Polarity Commutator 804 is represented by a low frequency half bridge configuration containing switches Q4 and Q5. Capacitor Cb is used as a blocking capacitor to pass only AC current. At the output, the LP (Low Pass) Filter represented by capacitor C_{f} and inductor L_{f} is used to reduce the current ripple injection to Power Line 107.

As would be clear to a person trained in the art, the grid connected inverter according to an embodiment of the present invention, adds an advantage of soft switching of all power components. Zero Voltage Switching (ZVS) of inverter 802 is achieved by the fact that the inductor Lₕ current is switching direction every half cycle of the switching cycle. Consequently, during the dead time following the turn OFF of one transistor in each of the half bridges of the inverter (switches Q₁, Q₂ and switches Q₃, Q₄), the current of Lₕ causes self commutating of the voltage of the mid point of the half bride, and the complementary switch will be turned ON under ZVS. The soft switching has the advantage of lowering the switching losses (of reducing the power and stresses of switches), and hence improving efficiency. Another advantage of the soft switching is the lowering of the spurious signals that may cause electromagnetic interferences. Polarity Commutator 804 is switching under zero voltage and current conditions—at the zero crossing of the line voltage. Furthermore, the rectifying diodes assembly 803, exhibits lower reverse recovery losses due to the fact that the current is controlled by the inductor Lₕ.

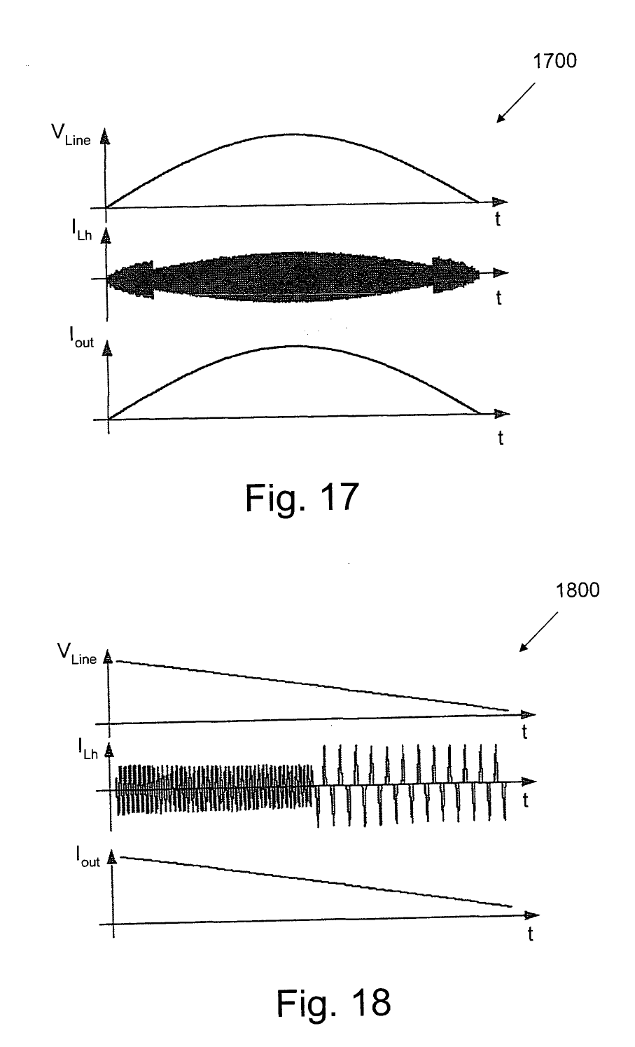

FIGS. 17 and 18 are schematic illustrations 1700 and 1800, respectively, of waveforms of a current I_{Lh} of inductor Lₕ (FIG. 8) and of an output current Iₒᵤₜ (FIG. 8), according to another embodiment of the present invention. FIG. 18 is a zoom of FIG. 17. In this embodiment the frequency is not increased beyond a predetermined value when low feed currents are required (at the beginning and at the end of a half mains cycle). Rather, the Duty cycle (that is, the relative duration that the switches are on) is varied according to the required current. By limiting the Duty cycle of the inverter's switches to below 50%, the current increase in Lₕ (I_{Lh}) is controlled such that the average feed current to the power line follows the desired shape. The advantage of this optional method is in the fact that the switching frequency is not allowed to increase to very high values that might cause increased switching losses. This operation is depicted in the plot of I_{Lh} of FIG. 18. Rather than increasing the frequency farther at low line voltages (and hence line currents), the switching frequency is kept at a constant value but the Duty cycle of the inverter's switches is controlled such that the average of the inductor current (I_{Lh}, shown as triangles) will be equal to the required average line current (shown in FIG. 15 as Iₒᵤₜ).

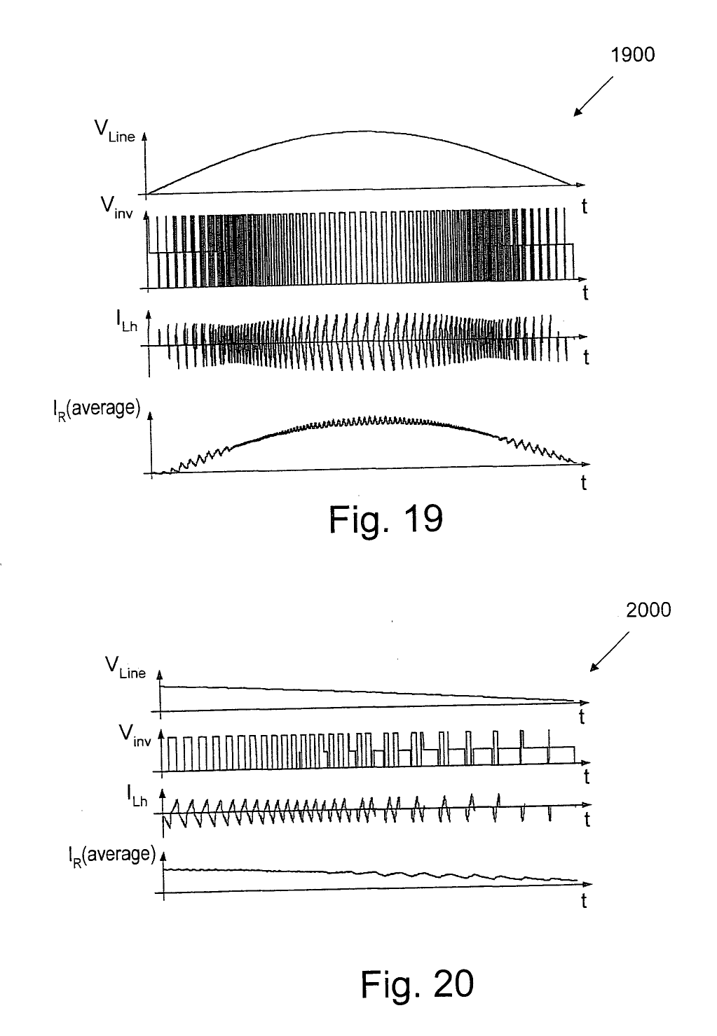

FIGS. 19 and 20 are schematic illustrations 1900 and 2000, respectively, of waveforms of a current I_{Lh} of inductor Lₕ (FIG. 8) and of a current I_{R}(average) (FIG. 11), according to still another embodiment of the present invention. FIG. 20 is a zoom of FIG. 19. Similarly to FIGS. 17 and 18, in this particular mode of operation, lower switching losses are also achieved. The switching frequency at low injected current is not increased beyond a predetermined value to avoid high switching losses. The frequency limit will be based on the type of switches used and other engineering considerations. According to an embodiment of the present invention, the frequency for low injection currents is kept at a constant low value, while the Duty cycle of switches (Q₁ to Q₄) of Inverter 802 (FIG. 8) is maintained at 50%. The control of the shape of the injected current is obtained in this case by dithering. That is, driving the sequence Q₁, Q₄ and Q₂, Q₃ transistors for few switching cycles, and then turning all transistors OFF for a period of time such that the average current fed to the line is at the required value. This ‘ON’ and ‘OFF’ sequence is similar to a PWM (Pulse Width Modulation) operation in which the ‘ON’ period constitute a number of switching cycles.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. An apparatus of a grid-connected switching inverter for injecting a current into a power line, comprising:
a. an electrical energy source for providing the substantially DC voltage to said apparatus;
b. a switching inverter connected to said electrical energy source for converting said substantially DC voltage of said electrical energy source to a high frequency alternating voltage;
c. a waveform generator for controlling the magnitude, shape and frequency of said alternating high frequency voltage outputted from said switching inverter by means of a control signal fed into said switching inverter;
d. an inductor connected to an output of said switching inverter for generating an alternating current of variable magnitude and frequency from said alternating high frequency voltage, wherein the magnitude of said alternating current depends on a frequency of said alternating high frequency voltage;
e. a rectifier connected in series with said inductor for rectifying said alternating current and for outputting a rectified unipolar alternating current, wherein the rectified average value of said alternating current is proportional to the absolute magnitude of the power line voltage; and
f. a polarity commutator connected to an output of said rectifier for converting said rectified unipolar alternating current into a bipolar alternating current, and for injecting said bipolar alternating current into a power line, wherein said bipolar alternating current is substantially in phase with and of shape of said power line voltage of said power line.

2. Apparatus according to claim 1, further comprising an MPPT unit for tracking the maximum power point of the electrical energy source.

3. Apparatus according to claim 1, wherein the electrical energy source is one or more of the following:
a. a solar cell;
b. a fuel cell;
c. a wind turbine;
d. a battery or accumulator; and
e. a generator.

4. Apparatus according to claim 1, wherein the switching inverter is an H-bridge or half bridge switching inverter.

5. Apparatus according to claim 1, wherein the polarity commutator is a H-bridge or half bridge polarity commutator.

6. Apparatus according to claim 1, wherein the polarity commutator comprises two or more switches that are driven by means of low frequency signals outputted from low frequency drivers.

7. Apparatus according to claim 1, wherein the magnitude of the alternating current of the inductor depends on the duty cycle of the control signal fed to the inverter.

8. Apparatus according to claim 7, further comprising a modulation unit for limiting the alternating current of the inductor to a predefined maximal frequency.

9. Apparatus according to claim 1, further comprising a line synchronizer for sensing the line voltage and generating corresponding synchronization commands.

10. Apparatus according to claim 1, further comprising an overvoltage protection unit for guarding said apparatus from dangerous DC voltage levels under no load conditions.

11. Apparatus according to claim 1, further comprising a microcontroller for controlling the operation of said apparatus.

12. Apparatus according to claim 1, further comprising a transformer for galvanically isolating the electrical energy source from the power line.

13. Apparatus according to claim 1, further implementing soft switching of the switches of the inverter for reducing the power and stresses of said switches.

14. Apparatus according to claim 1, further comprising a DC-DC converter, placed between the electrical energy source, and switching inverter for adjusting the voltage level of said electrical energy source to that required for said switching inverter.

15. Apparatus according to claim 1, wherein the alternating current is generated in the inductor due to imposing a bipolar high frequency voltage across said inductor.

16. Apparatus according to claim 13, wherein the alternating current in the inductor is controlled by varying the frequency of the bipolar high frequency voltage or by toggling the bipolar voltage signal ON and OFF.

17. Apparatus according to claim 13, wherein the alternating current in the inductor is controlled by varying the ON time within each switching period of the bipolar voltage.

18. A method for injecting a current into a power line, comprising:
a. providing an inductor, a terminal of which is, connected in series to a first input of a rectifier;
b. generating an alternating current of variable magnitude and frequency in said inductor by applying a high frequency voltage between the other terminal of said inductor and a second input of said rectifier;
c. rectifying said alternating current by means of said rectifier, thereby obtaining the magnitude of the rectified average value of the alternating current that is proportional to the absolute magnitude of the power line voltage;
d. commutating the polarity of the rectified alternating current to be synchronized with the phase of the power line current; and
e. injecting the synchronized rectified alternating current into said power line.

19. A method for injecting a current into a power line, comprising:
a. providing the substantially DC voltage by means of an electrical energy source;
b. converting said substantially DC voltage of said electrical energy source to a high frequency alternating voltage by means of a switching inverter connected to said electrical energy source;
c. controlling the magnitude, shape and frequency of said alternating high frequency voltage outputted from said switching inverter by means of a control signal fed into said switching inverter from a waveform generator;
d. generating an alternating current of variable magnitude and frequency from said alternating high frequency voltage by means of an inductor connected to an output of said switching inverter, wherein the magnitude of said alternating current depends on a frequency of said alternating high frequency voltage;
e. rectifying said alternating current and outputting a rectified unipolar alternating current by means of a rectifier connected in series with said inductor, wherein the rectified average value of said alternating current is proportional to the absolute magnitude of the power line voltage; and
f. converting said rectified unipolar alternating current into a bipolar alternating current and injecting said bipolar alternating current into a power line by means of a polarity commutator connected to an output of said rectifier, wherein said bipolar alternating current is substantially in phase with and of shape of said power line voltage of said power line.

20. Method according to claim 19, further comprising tracking the maximum power point of the electrical energy source by means of a MPPT unit.
